(19) United States
(12) Patent Application Publication
(10) Pub. No.: US 2007/0206903 A1
(43) Pub. Date: Sep. 6, 2007

(54) SBS reduction in optical media

(76) Inventor: George Kovar, Ottawa (CA)

Correspondence Address: SMART & BIGGAR;P.O. BOX 2999, STATION D, 900-55 METCALFE STREET, OTTAWA, ON, K1P5Y6, US

(21) Appl. No.: 11/714,239

(22) Filed: Mar. 6, 2007

Related U.S. Application Data
(60) Provisional application No. 60/778,927, filed on Mar. 6, 2006.

(51) Int. Cl. G02B 6/26; G02F 1/01; G02B 6/42

(52) U.S. Cl. 385/50; 385/122; 385/39; 385/1

(57) ABSTRACT

A method and arrangement for stimulated Brillouin scattering (SBS) reduction in optical media that generate SBS are provided. SBS is reduced by providing a plurality of segments of optical medium and providing an optical isolator between adjacent pairs of segments so as to reduce the SBS and thereby improve power throughput. The isolators prevent backward propagation of an SBS signal between the adjacent segments. A wavelength multiplier, a wavelength converter and a multi-wavelength laser source, which include the arrangement, are also provided.

### RELATED APPLICATION

This application claims the benefit of prior U.S. provisional application No. 60/778,927 filed Mar. 6, 2006, hereby incorporated by reference in its entirety.

### FIELD OF THE INVENTION

The present invention relates to media that may generate unwanted stimulated Brillouin scattering (SBS), for example optical communication media, and to devices and systems including such media, illustratively nonlinear optical devices, fiber wavelength converters or wavelength multipliers.

### BACKGROUND OF THE INVENTION

Nonlinear optical effects often need to be considered when launching high powers into an optical medium such as an optical fiber, including varieties of optical fiber such as linear fiber and highly nonlinear fiber, a waveguide or free-space. Due to the high confinement of power density in a fiber core over very long distances, for example, even modest power levels can lead to high power losses due to unwanted nonlinear effects in optical fiber. If the spectrum is narrow, the main limiting nonlinear optical effect is SBS, which can limit the transmission of a desired signal to as low as 10% of the launched power. In addition, since SBS starts from a spontaneously-emitted photon, the starting point of the SBS is random. Even a small amount of SBS can lead to instability of a transmitted signal, and therefore is undesirable.

As an approximation, it can be assumed that the SBS signal starts from noise at the back of the optical medium, such as optical fiber, and grows exponentially as it propagates towards the front. The fastest growth in SBS takes place near the front end. As a result, most of the input power is converted into SBS and reflected from the front of the optical link. An example of this is shown in FIG. 1 where the SBS effect within a fiber 10 of length L is illustrated, with the desired optical signal 17 travelling left to right along the fiber 10. The strength of the SBS is illustrated by the curve 15. The effect is greatest at the left, where the power of the input signal 17 is greatest, and where there is a cumulative effect of the SBS along the entire length L of the fiber 10. The weak transmitted signal is indicated at 11, and the large SBS reflection is indicated at 12.

Dithering, i.e. modulating, the wavelength of the optical signal is a scheme that has been widely applied to reduce the SBS. However, this method widens the optical linewidth (spectrum) of an optical signal and introduces some other side effects such as inserting a modulation frequency signature on the main optical signal. In some applications and optical systems, these effects and limitations are to be avoided.

There are also practical limitations on modulation of a signal. While semiconductor distributed feedback (DFB) lasers can be modulated, the wavelength of most other laser sources cannot be modulated. The wavelength of semiconductor lasers is accomplished by modulating the current. This has the undesirable side effect of modulating the laser power as well as the wavelength. In many applications, the amplitude modulation or the wavelength modulation, or both, are undesirable.

One additional problem with using dithering to reduce SBS arises in an application such as a wavelength multiplier that uses two seed lasers, as discussed in more detail below. The problem arises because the multiplier replicates the spacing of the two seed lasers. This means that any error in the spacing is also multiplied. For example, if channel 1 and 2 are the seed lasers, and their spacing has error x, then channels 21 and 22 will have a spacing error of 20x. The wavelength dither of the two seed lasers must therefore be exactly the same. If it is out of phase, or if the magnitude is not the same, then a spacing error will be introduced to the two seeds, and this spacing error will be multiplied in the generated channels.

### SUMMARY OF THE INVENTION

According to one aspect of the present invention, there is provided a method of producing an optical medium of length L comprising: providing a plurality of segments of optical medium each segment having a length less than L; providing a respective optical isolator between adjacent pairs of segments, so as to allow propagation of an optical signal through the plurality of optical medium segments and to reduce stimulated Brillouin scattering, and thereby improve power throughput.

In some embodiments, the plurality of segments of optical medium comprises at least one of: optical fiber segments; optical waveguide segments; and free-space segments.

In some embodiments, the optical fiber segments comprise highly nonlinear optical fiber.

In some embodiments, the method further comprises: determining a length of each of the segments such that within each segment SBS is kept below a defined threshold for a defined input power.

According to another aspect of the present invention, there is provided an optical arrangement comprising: a plurality of segments of optical medium arranged in sequence; a respective optical isolator between each pair of adjacent segments of the plurality of segments, the optical isolator(s) provided so as to allow propagation of an optical signal through the plurality of optical medium segments and to reduce stimulated Brillouin scattering, and thereby improve power throughput.

In some embodiments, the plurality of segments of optical medium comprises at least one of: optical fiber segments; optical waveguide segments; and free-space segments.

In some embodiments, the segments of optical fiber comprise highly nonlinear optical fiber.

In some embodiments, each of the segments has a length selected such that within each segment SBS is kept below a defined threshold.

In some embodiments, the defined threshold of each segment corresponds to a defined input power.

In some embodiments, a wavelength multiplier comprises the arrangement described above.

In some embodiments, a MWLS (multi-wavelength laser source) comprises the wavelength multiplier described above.

In some embodiments, the MWLS further comprises: at least two wavelength-dithered seed lasers operable to produce at least two wavelength-dithered seed laser signals, wherein the wavelength multiplier is operable to generate a comb of wavelength channels from the at least two wavelength-dithered seed laser signals.

In some embodiments, a wavelength converter comprises the arrangement described above.

According to yet another aspect of the present invention, there is provided a method comprising: propagating an optical signal through a plurality of optical medium segments in a first direction; and preventing propagation between adjacent segments of the plurality of optical medium segments in a second direction opposite to the first direction so as to reduce stimulated Brillouin scattering and thereby improve power throughput.

In some embodiments, propagating an optical signal through a plurality of optical medium segments in a first direction comprises propagating the optical signal through a plurality of successively longer lengths of optical medium segments in the first direction.

In some embodiments, the optical signal is a dense wavelength division multiplex (DWDM) optical signal.

In some embodiments, preventing propagation between adjacent segments of the plurality of optical medium segments in a second direction opposite to the first direction keeps SBS in each segment below a defined threshold.

In some embodiments, the defined threshold of each segment is defined for an input power of each segment.

In some embodiments, the plurality of optical medium segments comprises at least one of: optical fiber segments; optical waveguide segments; and free-space segments.

In some embodiments, the optical fiber segments comprise highly nonlinear optical fiber.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a plot illustrating an example of growth of SBS in a length of fiber;

FIG. 2 is a plot illustrating an example of growth of SBS in a length of fiber with isolators;

FIG. 3 is a schematic diagram of the multi-wavelength source based on nonlinear interactions in a fiber wavelength multiplier;

FIG. 4 is a plot of transmitted power as a function of input power over 800 m of fiber with 0, 1 and 3 equally-spaced isolators;

FIG. 5 is a plot of a typical output spectrum of the channel wavelength multiplier, with an inset showing an eye diagram for one of the channels; and

FIG. 6 contains plots of the linewidth of individual channels in a comb for SBS reduction by dithering the wavelength, and by using isolators.

### DETAILED DESCRIPTION

According to an embodiment of the invention, one or more optical isolators are inserted that block SBS power reflected backward along an optical medium. Each isolator functions to allow the desired signal to continue to propagate, and to block the SBS signal and any other reflected signals from propagating backward across the isolator. This prevents the rapid growth of the SBS. When SBS power is high, the rate of growth is high. When SBS power is low, the rate of growth is low. Each time the SBS signal reaches an isolator, it is forced to restart from near-zero power (essentially from noise), where the growth is slow. Since the SBS power is generated at the expense of the signal power (i.e., the signal power is converted into SBS), in order to maximize the signal transmission it may be desirable to minimize the SBS being generated. At the same time, minimizing the SBS also greatly reduces the noise in a desired signal. Depending on the application, the desired signal may be the transmitted signal or the signal converted to other wavelengths.

In some implementations, the isolators are placed so as to block substantially all SBS power every time the SBS is just about to reach threshold and force the SBS to restart from noise. When an isolator is referred to herein, any device that has the desired characteristic of allowing one-way optical transmission to take place is contemplated.

In some implementations, each segment of optical medium has a defined threshold that is defined for an input power of the segment. In implementations in which SBS is to be essentially eliminated, the defined threshold of each segment is defined as the SBS threshold and the isolators are placed so as to keep the power below the defined threshold, thereby virtually eliminating SBS. In some implementations, SBS is reduced or controlled rather than essentially eliminated. In these implementations, the defined threshold may be defined as being higher than the SBS threshold and the isolators are placed so as to keep the power below the defined threshold, thereby reducing but not eliminating the SBS in each segment. Therefore, the actual level of the defined threshold is an implementation specific detail.

In one example implementation, for a single isolator, transmitted power will be maximized when the isolator is placed half way through the optical medium. If each half of the optical medium is still long enough to produce significant SBS, another isolator can be added in the middle of each half. In principle, this can be repeated until the sections are short enough that the SBS stays below threshold everywhere in the optical medium. While successively dividing lengths of the optical medium in half and adding another isolator between each half will result in an even number of lengths of the optical medium, more generally an optical medium may be segregated into any number of lengths, odd or even, which are each separated by an optical isolator. For example, the optical medium may be separated into three lengths separated by two optical isolators. It should also be noted that optical medium segments need not necessarily be of the same length, as described below.

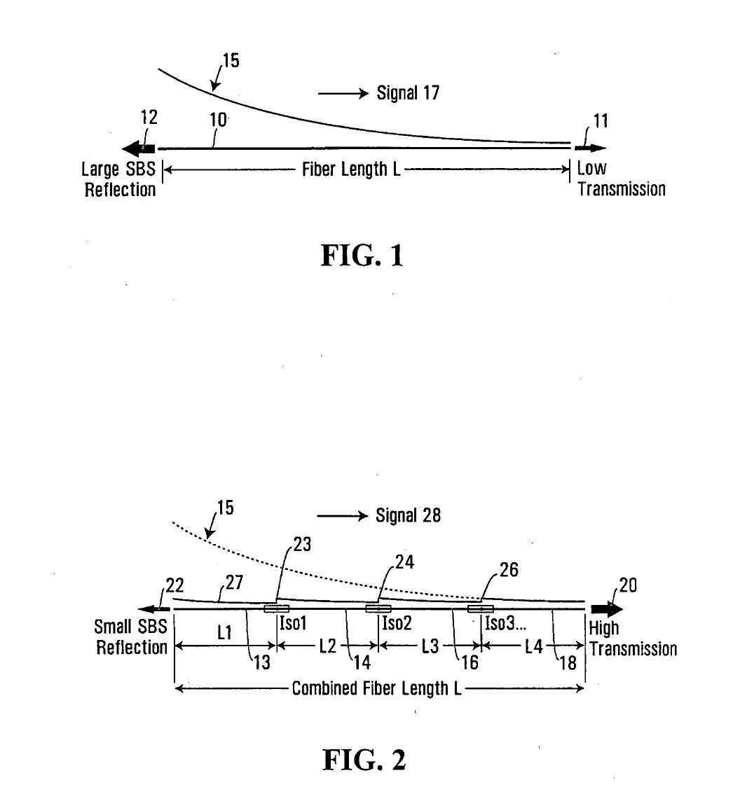

An example is shown in FIG. 2, where a length of fiber that corresponds to the length L of fiber 10 of FIG. 1 is shown separated into four segments 13,14,16,18 of length L1,L2,L3,L4 respectively, i.e. L1+L2+L3+L4=L, and optical isolators 23,24,26 are inserted between adjacent segments. The SBS effect of this embodiment is indicated at 27, while the SBS effect resulting from an optical fiber of length L without the optical isolators 23,24,26, i.e. the fiber 10 shown in FIG. 1, is indicated at 15. The transmitted signal is indicated at 20, and the SBS reflection is indicated at 22. The transmit signal 20 has a power relatively greater than the power of signal 11 of FIG. 1, and the SBS reflection 22 is relatively smaller than the SBS reflection 12 of FIG. 1.

In some embodiments, the fiber span of length L is implemented with two fiber segments and an optical isolator such that the optical isolator is provided between the adjacent fiber segments.

In some embodiments, a fiber span of length L can be subdivided into more than two segments, with an optical isolator separating the adjacent fiber segments.

In general, the optimum number of segments depends on the system under consideration. Any or all of the following characteristics may be taken into account: the total length L of the fiber, the core diameter, the launched power, the desired power at the output, and the acceptable noise level in the signal at the output. In addition, the isolators introduce a loss into the link, as do the splices at the isolators. These are linear losses (i.e., independent of signal power level), and in some applications they may be less of a problem than the nonlinear (power-dependent) losses caused by SBS. In certain applications, such as wavelength conversion, or wavelength multiplication, the signal entering the fiber is continuously being converted into signals at other wavelengths, and therefore the signal power is rapidly decreasing, and eventually falling below the SBS threshold. In this case, the isolators will be mainly required at the start of the fiber, and the optimum segments will not be of the same lengths. At the start of the fiber, the segment lengths may be short, with segments increasing in length farther down the link.

The optimum segment lengths and number of isolators may therefore be determined for each system individually, through simulation or experiment. In operation, as an approximation, it can be assumed that as the optical signal propagates from left to right through the lengths L1,L2,L3,L4 of the fiber segments 13,14,16,18 the SBS effect 27 starts from noise at the back, or right end of the fourth fiber segment 18. The SBS effect 27 grows in strength as it propagates backwards right to left along the length L4 of the fourth fiber segment 18 until it encounters the third isolator 26. The third isolator 26 prevents the backwards propagation of the SBS 27 and therefore the SBS 27 must begin again from noise at the right end of the third fiber segment 16. The second isolator 24 will block the SBS 27 generated by the third fiber segment 16 from propagating backwards through to the second fiber segment 14 and the first isolator will do the same for the SBS 27 generated by the second fiber segment 14. Therefore, by forcing the SBS 27 to restart from noise at the end of each fiber segment 13,14,16,18, only SBS 27 started from noise at the right end of the first fiber segment 13 and generated along its length L1 will contribute to the small SBS reflection signal 22. Because the SBS 27 is prevented from passing threshold, very little of the optical power of the optical signal 28 is converted into SBS and therefore the transmitted signal 20 is strong in comparison to the weak transmitted signal 11 shown in FIG. 1.

In another embodiment, the positions of the isolators are not equally spaced, but rather are spaced to account for the fact that power drops along the length of an optical medium, and therefore potentially each subsequent spacing can be longer than the previous one. Simulations and or experiments can be performed to determine the positioning of isolators that results in the best improvement for a given number of isolators. A specific example of this is given below.

Using a combination of simulations and experimental measurements, it was demonstrated that placing equally spaced isolators in a long length of fiber does indeed raise the SBS threshold, and increases the transmission at high power. Example simulation and experimental results are shown in FIG. 4 where an 800 m section of fiber was employed as a starting point. The simulation and experimental results show the transmitted power vs. the input power for three configurations: a configuration with no isolators, a configuration with one isolator and a configuration with three isolators. The simulation results are shown in the chart on the left in FIG. 4, while the experimental results are shown in the chart on the right in FIG. 4. With other actual or simulation conditions, similar or possibly different results may be achieved.

In a most general case, it is not necessary for a specific spacing to be employed between isolators since the inclusion of any isolators will result in some benefit. In some embodiments, the spacing between isolators is selected so as to keep the power just below the SBS threshold. Simulations can be performed to determine the maximum distances between isolators that will keep the power just below the SBS threshold, thereby allowing the number of isolators required to be minimized. Similar simulations can be performed for other applications. Alternatively, isolator spacings can be determined experimentally with the same objective in mind.

The simulations show that without an isolator the power 44 transmitted through 800 m of SMF fiber is clamped at 100 mW. In other words, increasing the input power does not result in any increase in the output power 44, mainly due to SBS effects. For the simulation configuration with one isolator, the transmitted power 42 can be increased to approximately 150 mW. If three equally spaced isolators are used, the simulation predicts that the transmitted power 40 can be increased to 250 mW.

The experimental results show that for the configuration without an isolator, the transmitted power 45 is clamped at approximately 100 mW, which is in good agreement with the simulation result for this configuration. For the experimental configuration with one isolator, the transmitted power 43 can be increased to approximately 150 mW, which matches the simulation result for this configuration. If three equally spaced isolators are used, the experimental results report that the transmitted power 41 can be increased to approximately 225 mW, which is slightly below the results predicted by the simulation for this configuration. In the simulation, the isolators were assumed to have an insertion loss of 0.2 dB. The insertion loss of the isolators used in the experiment was higher than the 0.2 dB used in the simulation, which accounts for the slightly lower transmitted powers in the experimental results. It should be noted that isolators with insertion loss less than 0.2 dB could be procured.

It is noted that for a constant power implementation (without pump depletion), the optical isolators may need to be closely spaced, in which case the entire fiber link might include 20 or more isolators to maintain SBS below threshold. The losses in the isolators and the splices would then add up to a high overall loss. However, in some applications, such as the wavelength channel multiplier discussed below, the launch power of an input optical signal quickly drops off and therefore relatively few isolators may be utilized. In the case of the wavelength channel multiplier, the launch power of the seed laser sources drops off quickly as the power in the seed channels is transferred to other channels in a comb output. This can greatly reduces the number of isolators to be used.

There is a large number of applications that would benefit from such an SBS reduction technique. Among others, these include applications that simply need to maximize the amount of transmitted power over a given span of fiber or other optical medium. These applications include normal telecommunication fiber transmission, as well as power-over-fiber devices (devices which use optical power to generate electricity at the remote end point of the fiber link). Other applications include high power nonlinear devices such as wavelength converters or wavelength channel multipliers. The main function of a wavelength converter is to take a signal at a given wavelength and convert it to some other wavelength without altering any other properties of the signal, for example, linewidth. The nonlinear process responsible for the desired conversion is usually much weaker than SBS, and will be severely hindered unless SBS is eliminated. A wavelength channel multiplier is a similar device. Its main function is to take a signal, and replicate it throughout a wide band of the spectrum, forming a wide comb of wavelengths, similar in nature to the original signal. The applicability of the SBS reduction approach is detailed below as it applies to a wavelength channel multiplier, however the implementation would be similar in the other applications.

### Application to Multi-Wavelength Laser Source

There is a high level of interest in Multi-wavelength laser sources (MWLS) due to their possible applications in Dense Wavelength Division Multiplexing (DWDM) communication, and in test and measurement systems. In communications, multi-wavelength sources are desired because the use of single wavelength sources multiplexed on to one fiber becomes increasingly complex as the number of channels increases. In test and measurement applications, a multi-wavelength laser that can replace a rack of single wavelength sources is an ideal source for characterization of DWDM subsystems, modules and components. The typical requirements for such comb sources are a large number of wavelengths, uniform power and frequency spacing, a high peak to valley ratio and good stability. Narrow linewidths and the precise positioning of the comb on the ITU (International Telecommunications Union) grid are required for some applications.

Wavelength multipliers that can multiply one or two wavelength channels to produce a large number of channels are one of the attractive solutions to replace racks of multiplexed individual laser sources. A multi-wavelength source based on wavelength multiplication using nonlinear effects in optical fiber has been presented previously in U.S. Pat. No. 6,826,207 by J. D. Xu, et al, hereby incorporated by reference in its entirety. This method has been shown to be able to generate over forty channels at 100GHz spacing, from a pair of seed lasers. High power seed lasers are required for this nonlinear interaction to generate a wide comb, covering the entire C-band or L-band. In that patent, the usual approach of dithering the seed lasers is applied.

By employing the SBS suppression technique described above, in which the path of the reflected SBS signal is blocked, the need for dithering of the seed laser wavelengths is greatly reduced, or completely eliminated. For the wavelength channel multiplier application, the linewidths of the generated channels are then much closer to the seed lasers, and true CW (continuous wave) operation, without residual amplitude modulation, is possible.

The SBS reduction technique is particularly effective in systems that perform wavelength channel multiplication, and to other similar applications. One reason for this is that in a wavelength channel multiplier, the pump power quickly spreads from the seeds to adjacent channels. These new channels do not contribute to the build-up of SBS, since their Brillouin gain is at a different wavelength. As the other channels grow, the power in the seed channels drops. Because of this, the separation between optical isolators can be increased, as the same amount of build up of SBS will occur over progressively longer sections of wavelength multiplying medium.

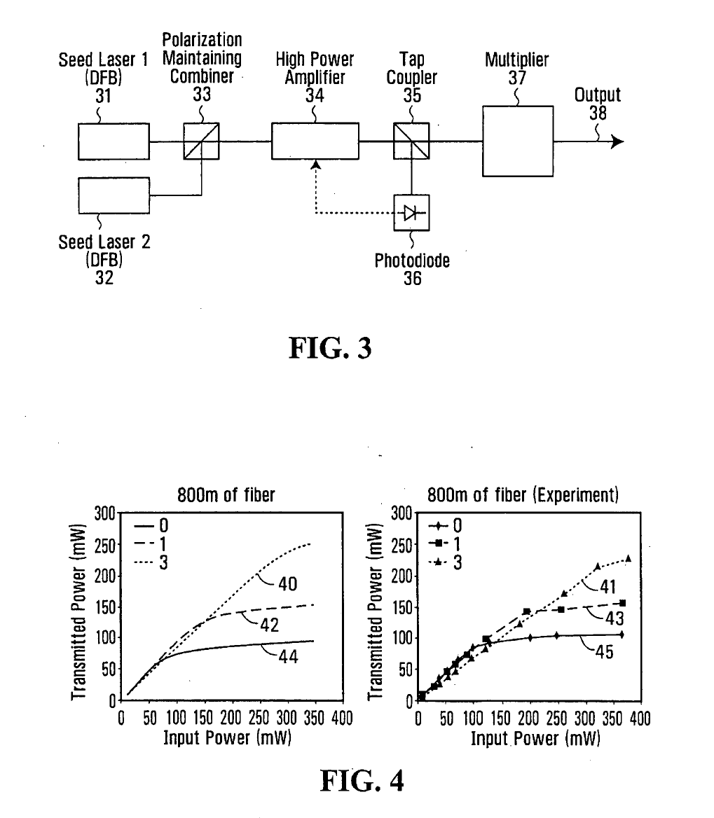

FIG. 3 is an optical schematic based on the technique for nonlinear wavelength channel multiplication that was previously described in detail in the above-referenced U.S. Pat. No. 6,826,207. Two seed DFB (distributed feedback) lasers 31,32 are functionally connected to respective inputs of a polarization maintaining combiner 33. An output of the polarization maintaining combiner 33 is functionally connected to an input of a high power amplifier 34. An output of the high power amplifier 34 is functionally connected to an input of a tap coupler 35. A first output of the tap coupler 35 is functionally connected to an input of a wavelength channel multiplier 37, while a second output of the tap coupler 35 is functionally connected to an input of a photodiode 36. An output of the photodiode 36 is functionally connected to a control input of the high power amplifier 34 to form a feedback loop for control of the power amplifier 34. The wavelength channel multiplier 37 provides an output signal 38.

In operation, outputs of the two seed DFB lasers 31,32 are combined by the polarization maintaining combiner 33 to form a beat signal. The high power amplifier 34 boosts the total power of the beat signal. In some implementations, the high power amplifier boosts the total power of the beat signal to more than 600 mW. The optical tap coupler 35 taps a small portion of the power amplified beat signal to the photodiode 36 and passes a majority of the power amplified beat signal to the wavelength channel multiplier 37. The wavelength channel multiplier 37 replicates the seed lasers into a comb output 38 of similar sources, separated in frequency by the same spacing as that between the two seed lasers.

In some embodiments, the power to the wavelength channel multiplier 37 is kept constant. This can be achieved by a control loop as shown in the figure, wherein the photodiode 36 detects the power of the power amplified beat signal and then controls the high power amplifier 34 in order to maintain the power at a constant level.

In some embodiments, the wavelength channel multiplier 37 is a completely passive device, containing several long sections of dispersion shifted and single mode fiber. It relies on self-phase modulation (SPM), cross phase modulation. (XPM) and four wave mixing (FWM) to generate the comb. The two high power seed channels generated by the two DFB seed lasers 31,32 constitute the pump to the wavelength channel multiplier 37.

The SBS reduction method described above can be used in the wavelength channel multiplier 37 component of the FIG. 3 implementation. Compared with using a dither signal on the lasers, the new SBS reduction method may result in a narrower effective linewidth, no wavelength modulation and no residual amplitude modulation of the output channels in the comb output 38. Taken one at a time, the channels should produce a truly Continuous Wave (CW) polarized output. Except for their wavelength, the output channels are a scaled replica of the original seed laser sources.

As an example, a simulation model of a wavelength channel multiplier without optical isolators was constructed and optimized for spectrum flatness over 40 channels at 100GHz spacing, covering the C-band. The powers of the seed channels and the nearest neighbors were then calculated along the entire length of the multiplier. Once the power of the seeds was known at all points inside the multiplier, optimized locations for each isolator could be determined. For one design, 8 isolators were used for the entire multiplier. Distances between the isolators also depended on the powers launched, spacing of the seed lasers, core size of the fiber and some other factors. For this example design, the distances of the isolators were 140 m, 288 m, 447 m, 620 m, 812 m, 1030 m, 1293 m and 1642 m, respectively.

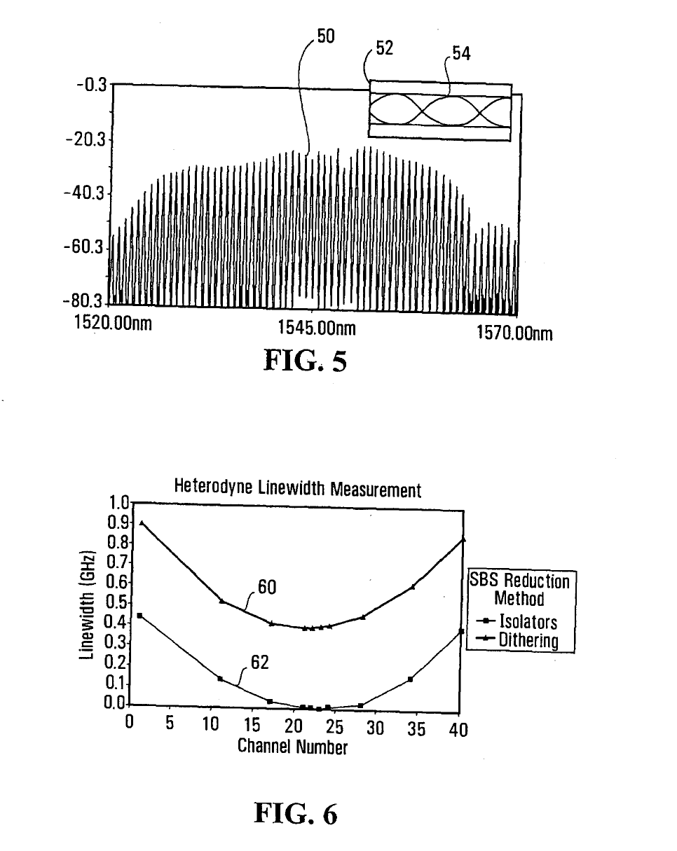

The experimental output spectrum 50 of this wavelength channel multiplier with 8 isolators is shown in FIG. 5 and has a flatness of about 10 dB over the 40 channels of interest. The amount of power lost to SBS is negligible and does not affect the shape of the output spectrum. In the time domain however, even a small amount of SBS is enough to cause power instability. A very small amount of dither can be employed to eliminate this fluctuation. However, instead of 5 pm sometimes conventionally used to deal with SBS problem, a dither of only 0.3 pm was required to eliminate all SBS in this particular example.

The dither is introduced in one embodiment by adding a 10 MHz triangular wave current modulation to the DFB seed lasers. Alternatively, an additional isolator could be employed to completely eliminate the need for any dither at all.

Finally, each channel was modulated at 2.5 Gb/s, with a 2¹⁵-1 bit pseudorandom sequence. The inset 52 in FIG. 5 shows the resulting eye diagram 54 for one of the channels, after 100 km propagation in SMF-28 fiber. This result is a significant improvement over the same device in which SBS was reduced by wavelength dithering. In those experiments, the eye was nearly completely closed.

FIG. 6 compares the channel linewidths of the two schemes of SBS reduction: wavelength dithering 60 and the SBS reduction technique according to an embodiment of the present invention 62. There is a factor of 2 improvement in the channel linewidths at the edges of the comb and a factor of 50 improvement near the center. It should be noted that with the isolators, the SBS was almost completely eliminated, whereas with the dither signal, the SBS was only reduced enough to get the required number of channels. The difference in linewidths would be much larger if the SBS was completely eliminated in both cases.

What has been described is merely illustrative of the application of the principles of the invention. Other arrangements and methods can be implemented by those skilled in the art without departing from the spirit and scope of the present invention.

For example, optical fiber is described above as one example of an optical communication medium. Embodiments of the invention may be implemented in conjunction with other types of media capable of transmitting optical signals, whether used in communications or other applications.

1. A method of producing an optical medium of length L comprising:
providing a plurality of segments of optical medium each segment having a length less than L;
providing a respective optical isolator between adjacent pairs of segments, so as to allow propagation of an optical signal through the plurality of optical medium segments and to reduce stimulated Brillouin scattering, and thereby improve power throughput.

2. The method of claim 1, wherein the plurality of segments of optical medium comprises at least one of: optical fiber segments; optical waveguide segments; and free-space segments.

3. The method of claim 2, wherein the optical fiber segments comprise highly nonlinear optical fiber.

4. The method of claim 1 further comprising:
determining a length of each of the segments such that within each segment SBS is kept below a defined threshold for a defined input power.

5. An optical arrangement comprising:
a plurality of segments of optical medium arranged in sequence;
a respective optical isolator between each pair of adjacent segments of the plurality of segments, the optical isolator(s) provided so as to allow propagation of an optical signal through the plurality of optical medium segments and to reduce stimulated Brillouin scattering, and thereby improve power throughput.

6. The optical arrangement of claim 5, wherein the plurality of segments of optical medium comprises at least one of: optical fiber segments; optical waveguide segments; and free-space segments.

7. The optical arrangement of claim 6, wherein the segments of optical fiber comprise highly nonlinear optical fiber.

8. The optical arrangement of claim 5 wherein:
each of the segments has a length selected such that within each segment SBS is kept below a defined threshold.

9. The optical arrangement of claim 8 wherein the defined threshold of each segment corresponds to a defined input power.

10. A wavelength multiplier comprising the arrangement of claim 5.

11. A MWLS (multi-wavelength laser source) comprising the wavelength multiplier of claim 10.

12. The MWLS of claim 11, further comprising:
at least two wavelength-dithered seed lasers operable to produce at least two wavelength-dithered seed laser signals, wherein
the wavelength multiplier is operable to generate a comb of wavelength channels from the at least two wavelength-dithered seed laser signals.

13. A wavelength converter comprising the arrangement of claim 5.

14. A method comprising:
propagating an optical signal through a plurality of optical medium segments in a first direction; and
preventing propagation between adjacent segments of the plurality of optical medium segments in a second direction opposite to the first direction so as to reduce stimulated Brillouin scattering and thereby improve power throughput.

15. The method of claim 14, wherein propagating an optical signal through a plurality of optical medium segments in a first direction comprises propagating the optical signal through a plurality of successively longer lengths of optical medium segments in the first direction.

16. The method of claim 14, wherein the optical signal is a dense wavelength division multiplex (DWDM) optical signal.

17. The method of claim 14, wherein preventing propagation between adjacent segments of the plurality of optical medium segments in a second direction opposite to the first direction keeps SBS in each segment below a defined threshold.

18. The method of claim 17, wherein the defined threshold of each segment is defined for an input power of each segment.

19. The method of claim 14, wherein the plurality of optical medium segments comprises at least one of: optical fiber segments; optical waveguide segments; and free-space segments.

20. The method of claim 19, wherein the optical fiber segments comprise highly nonlinear optical fiber.
